(19) United States
(12) Patent Application Publication
(10) Pub. No.: US 2010/0193985 A1
(43) Pub. Date: Aug. 5, 2010

(54) STEAM ROOM OF FOAMED RESIN MOLDING MACHINE, FOAMED RESIN MOLDING MACHINE, AND METHOD FOR MOLDING FOAMED RESIN

(75) Inventors: Naoyuki Umeda, Gifu-Prefecture (JP); Yasushi Numata, Gifu-Prefecture (JP); Makoto Nishio, Gifu-Prefecture (JP)

Correspondence Address: BURR & BROWN, PO BOX 7068, SYRACUSE, NY, 13261-7068, US

(73) Assignee: DAISEN CO., LTD., Nakatsugawa-shi, Gifu (JP)

(21) Appl. No.: 12/065,117

(22) PCT Filed: Oct. 17, 2007
(86) PCT No.: PCT/JP2007/001125

§ 371 Date: Apr. 2, 2008

(30) Foreign Application Priority Data
Aug. 20, 2007 (JP) 2007-213279

(51) Int. Cl. B29C 44/34; B29C 44/58

(52) U.S. Cl. 264/51; 425/4 R

(57) ABSTRACT

The present invention provides a steam room of a foamed resin molding machine that is superior in terms of heat insulation property and durability, a foamed resin molding machine, and a method for molding a foamed resin. At least one of frames, back plates and center plates that together constitute steam rooms of a foamed resin molding machine are made of foamed aluminum. Alternatively, foamed aluminum plates are laminated onto the frames or the back plates are constituted into a sandwiched structure that incorporates interposed foamed aluminum plates, respectively. The foamed aluminum is advantageous in that its high heat insulation property prevents waste in thermal energy of steam, and other merits include reductions in cycle times.

### TECHNICAL FIELD

The present invention relates to a steam room of a foamed resin molding machine, a foamed resin molding machine equipped with the steam room, and a method for molding a foamed resin, an invention that is capable of reducing losses in thermal energy of the steam.

### BACKGROUND ART

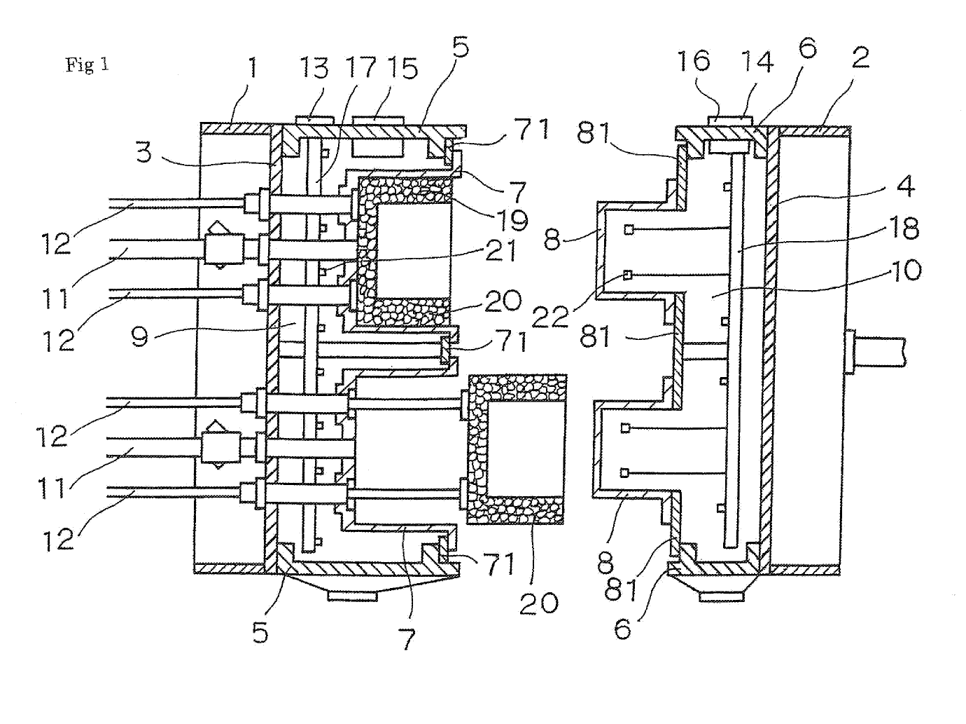

A conventional foamed resin molding machine has a structure that is shown in FIG. 1, for example. Specifically, a back plate 3 and a frame 5 (at a fixed side) are attached to a fixed-side die plate 1. A recessed die (at a fixed side) is attached to the frame 5 via a center plate 71. The back plate 3, the frame 5, the center plate 71, and the recessed die 7 together constitute a steam room 9. A raw material-filling machine 11 and ejector pins 12 are attached to the back plate 3 from its back surface after passing through the steam room 9. A cooling water introduction section 13 and a steam introduction section 15 are provided on the frame 5, and a cooling water pipe 17 is connected to the cooling water introduction section 13.

A back plate 4 and a frame 6 (at a movable side) are attached to a movable-side die plate 2. A protruded die (at a movable side) 8 is attached to the frame 6 via a center plate 81. The back plate 4, the frame 6, the center plate 81, and the protruded die 8 together constitute a steam room 10. A cooling water introduction section 14 and a steam introduction section 16 are attached to the frame 6, and a cooling water pipe 18 is connected to the cooling water introduction section 14. The recessed die 7 and the protruded die 8 are mated into a single unit so as to form a cavity 19.

To form a molded body by means of the foamed resin molding machine described above, a raw material composed of a foamed resin is poured into the cavity 19 by means of the raw material-filling machine 11. Next, steam is introduced into the steam rooms 9, 10 from the steam introduction sections 15, 16, and further, steam is also introduced into the cavity 19 through steam holes (not shown) that have been drilled into the recessed die 8 and the protruded die 9, so as to heat the raw material. The raw material that has thus been heated foams and fuses into a desired molded body. At this time, the dies 7, 8 and the frames 5, 6 are heated up to a high temperature of around 120° C.

Thereafter that, cooling water is supplied from the cooling water introduction sections 13, 14 via the cooling water pipes 17, 18, and the cooling water is sprayed from the nozzles 21, 22 onto the back surfaces of the recessed die 7 and the protruded die 8 so as to cool the molded body 20 within the cavity 19. The dies 7, 8 and the frames 5, 6 are cooled down to a low temperature of around 40° C. After completion of the cooling, the recessed die 7 and the protruded die 8 are separated and opened, and the molded body 20 is pushed out by the ejector pins 12.

In the molding step described above, the steam introduced into the steam rooms 9, 10 not only heats the raw material within the cavity 19, but also heats the back plates 3, 4, the frames 5, 6, and the center plates 71, 81, which together constitute the steam rooms 9, 10, and even the recessed die 7 and the protruded die 8. Further, at the time that the molded body 20 is cooled within the cavity 19, the recessed die 7 and the protruded die 8, and simultaneously, the back plates 3, 4, the frames 5, 6, and the center plates 71, 81, are also cooled by water sprayed from the nozzles 21, 22. However, among such structural members constituting the steam rooms, members other than the recessed die 7 and the protruded die 8 do not exert any influence on the quality of the molded body. Every time that the steps of cooling and heating these other members are repeated, thermal energy of the steam is wasted. Specifically, a significant portion of the thermal energy of the steam is devoted to heating items of equipment such as the frames 5, 6.

In an attempt to reduce waste in thermal energy of the steam such as has been described above, Patent Documents 1 and 2 respectively disclose a structure wherein a rubber lining or a coating layer that is obtained by thermally curing a thermosetting water-soluble resin is formed on the steam room sides of the back plates 3, 4, the frames 5, 6, and the center plates 71, 81 respectively, except for the recessed die 7 and the protruded die 8. This structure is capable of reducing the degree of waste in energy of the steam by means of thermal insulation achieved with the rubber lining layer or the coating layer. However, rubber lining layers or coating layers made of resin inevitably deform and peel off as the result of the thermal stress that is applied thereto during repeated steps of heating and cooling, and the steam enters into the structure through the peeled portion to impair the heat insulation effects. Thus, lifespans have been curtailed as the result of repeated use.

Patent Document 1: Japanese Laid-Open Patent Publication No. H05-212810 (FIG. 1)

Patent Document 2: Japanese Laid-Open Patent Publication No. 2006-212814 (FIG. 1)

### DISCLOSURE OF THE INVENTION

### Problems Which the Invention Solves

In view of the problems experienced in the prior art described above, an objective of the present invention is to provide a steam room of a foamed resin molding machine that is superior in terms of heat insulation property and durability, a foamed resin molding machine equipped with the steam room, and a method for molding a foamed resin.

### Means by Which the Problems is to be Solved

The steam room in a foamed resin molding machine which has been made to achieve the objective described above, is characterized in including: a die; a frame; a back plate; and a center plate, wherein at least one of the frame, the back plate, and the center plate is made of a porous metal for the purpose of heat insulation. The steam room in a foamed resin molding machine is characterized in including: a die; a frame; a back plate; and a center plate, wherein a porous metal for heat insulation is laminated on an inner surface of at least one of the frame, the back plate, and the center plate. The steam room in a foamed resin molding machine is characterized in including: a die; a frame; a back plate; and a center plate, wherein the back plate is constituted in a sandwiched structure that includes a porous metal plate for heat insulation and that is laminated so as to be interposed between metal plates. Foamed aluminum or foamed magnesium may be employed as the porous metal for heat insulation.

The foamed resin molding machine is characterized in including the steam room. Further, the method for molding a foamed resin is characterized in including a step of foaming and molding a raw material of thermoplastic resin particles by means of the kind of the foamed resin molding machine described above.

### Effect of the Invention

In the invention recited in claim 1, members such as the frames and back plates that constitute the steam rooms are made of a porous metal. Due to the heat insulation effects brought about by the porous metal, the thermal energy of the steam is never wasted. Further, unlike a coating layer made of resin, the frames and back plates neither deform nor peel off, and thus, no reduction in heat insulation effects occurs as a result of the deterioration caused by the passage of time.

In the inventions recited in claims 2 and 3, the porous metal is laminated onto members such as the frames and the back plates that constitute the steam rooms. Alternatively, the back plates are respectively constituted into a sandwiched structure that incorporates a porous metal laminated thereto. This lamination structure achieves an enhanced degree of heat insulation effects.

In the invention recited in claim 4, foamed aluminum or foamed magnesium is used as a material for the members. Thus, reductions in the weights of members can be achieved, and thereby reductions in the load applied to a device for driving (i.e. opening and closing) the movable die plate. Since the heat transfer properties of the material of the present invention are lower than those of conventional materials, and rates of heat transfer are low, the amount of heat released from the frames is small, and damage to peripheral equipment is minor.

In the invention recited in claim 5, since the heating and repeating steps can be conducted effectively, reductions in cycle times can be achieved. Significant effects which have proved impossible to achieve in conventional foamed resin forming machines can be achieved. In other words, since the amount of steam that is used is reduced, the amount of heavy oil consumed can also be reduced, and reductions in costs are thereby achieved.

In the invention recited in claim 6, a molded body can be produced at a low cost without the thermal energy of the steam being wasted.

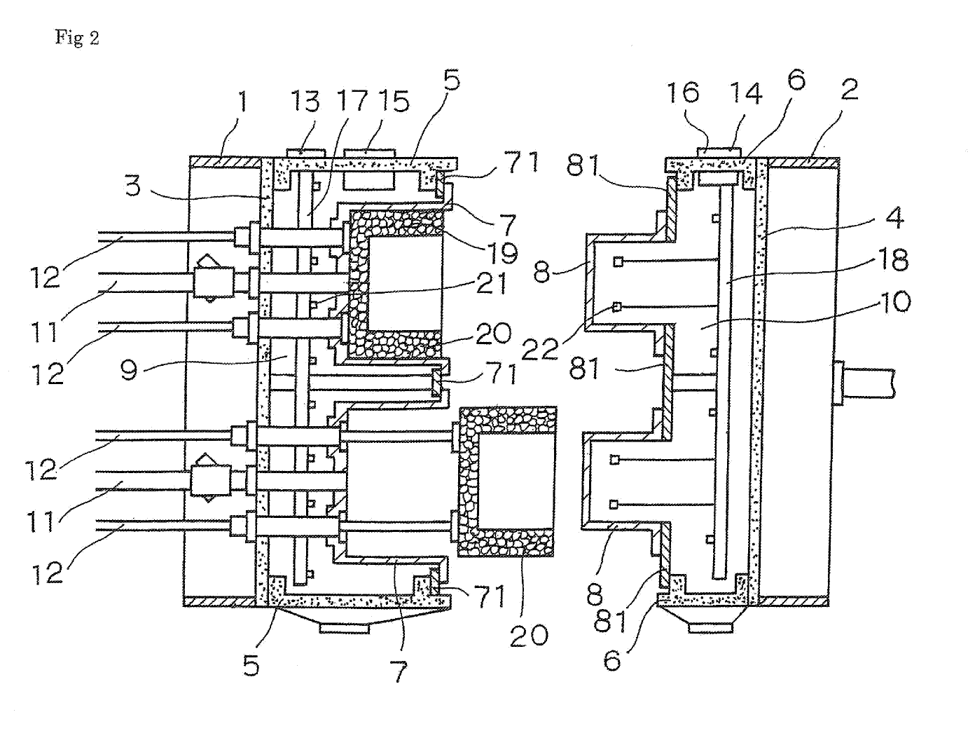

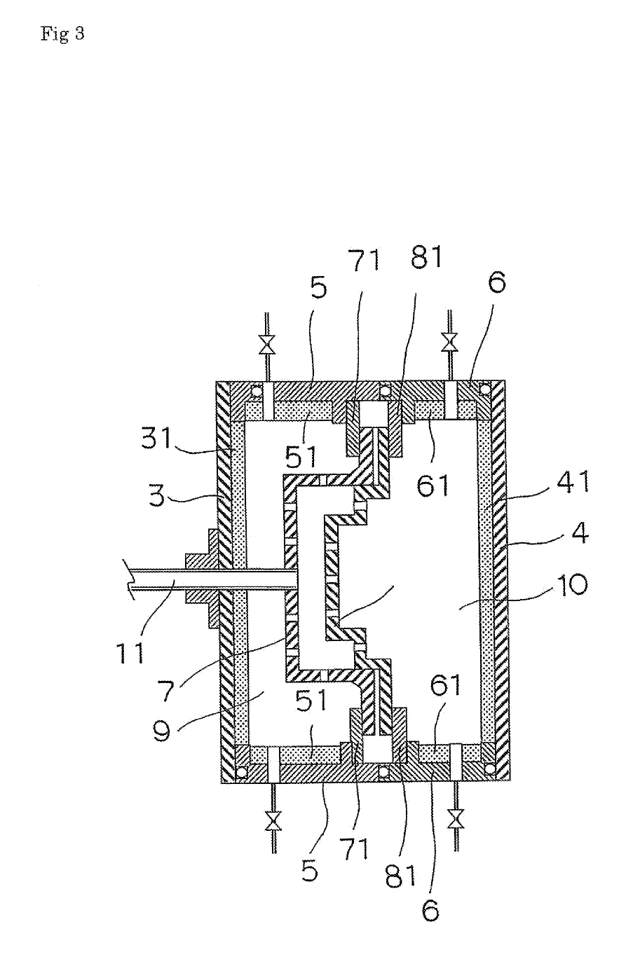

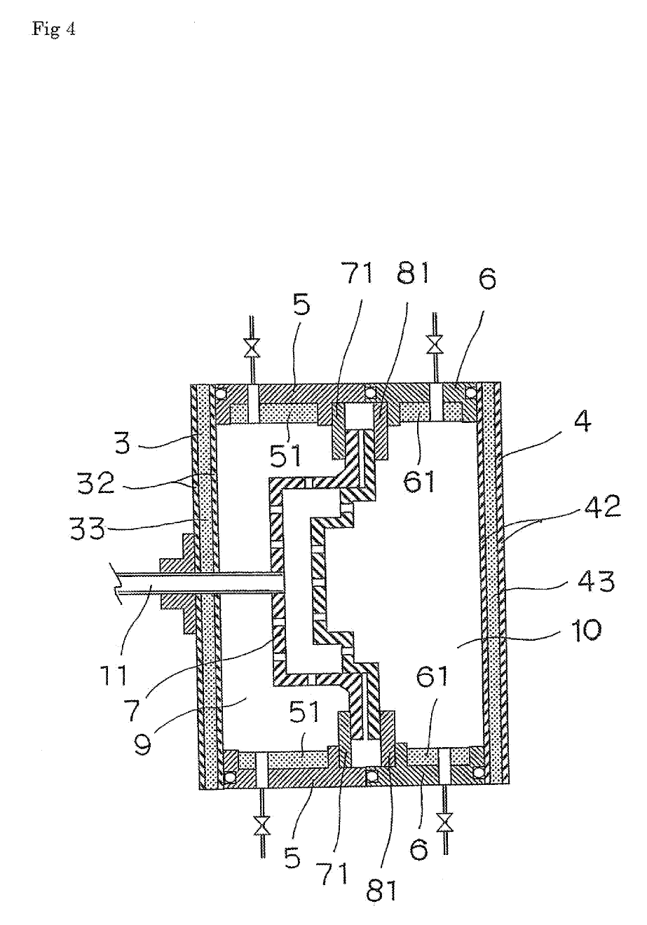

### BRIEF DESCRIPTION OF THE DRAWINGS

[FIG. 1] A schematic structural diagram of a foamed resin molding machine.

[FIG. 2] A schematic structural diagram of a foamed resin molding machine including a frame and a back plate made of a porous metal.

[FIG. 3] A schematic structural diagram of a foamed resinmolding machine including a steam room on to the interior of which a porous metal has been laminated.

[FIG. 4] A schematic structural diagram of a foamed resin molding machine including a back plate having a sandwiched structure.

### DESCRIPTION OF REFERENCE NUMERALS

3,4: Back plate, 5, 6: Frame, 9. 10: Steam room, 71, 81: Center plate, 33, 43, 51, 61: Foamed aluminum plate

### BEST MODE FOR CARRYING OUT THE INVENTION

Hereinafter, an embodiment of the present invention will be described based on FIG. 2.

The basic structure of the foamed resin molding machine of the present invention is not specifically different from that of conventional machines. Specifically, a fixed-side die plate 1 includes a steam room 9 consisting of a back plate 3, a frame 5, a center plate 71, and a recessed die 7. A raw material-filling machine 11 and ejector pins 12 are provided on the back plate 3 after passing through the steam room 9. A cooling water introduction section 13 and a steam introduction section 15 are provided on the frame 5. To the cooling water introduction section 13, a cooling water pipe 17 is connected.

A movable-side die plate 2 is formed with a steam room 10 consisting of a back plate 4, a frame 6, a center plate 81, and a protruded die 8. A cooling water introduction section 14 and a steam introduction section 16 are provided on the frame 6. To the cooling water introduction section 14, a cooling water pipe 18 is connected. The recessed die 7 and the protruded die 8 together constitute a cavity 19. A steam hole (not shown) is provided on the recessed die 7 and the protruded die 8, and the cavity 19 and the steam rooms 9, 10 are made so as to communicate with one another.

In the foamed resin molding machine structured as described above, the back plates 3, 4 and the frames 5, 6 are made of foamed aluminum which is a porous metal. To achieve an enhanced degree of heat insulation effects, it is desirable that the center plates 71, 81 also be made of foamed aluminum.

To produce the foamed aluminum, a hydrogen-absorbing alloy powder is added to fused aluminum which is in the process of solidification, the aluminum is accordingly induced to release hydrogen and the hydrogen that is thus released expands the fused aluminum into the foamed aluminum. A foamed aluminum material that is obtained in this manner is known as a super-lightweight material having a thin film cell structure with independent bubbles. The foamed aluminum has a heat transfer property of about 3.18 Kcal/m·h·° C. This value is about 1/60 of that of regular metal aluminum, and thus, is minor. The specific gravity of the foamed aluminum is 0.2 to 0.3. This value is about 1/10 of that of regular metal aluminum, and thus, the foamed aluminum is light in weight. As a material for the porous metal, materials such as magnesium, zinc and copper may alternatively be employed instead of aluminum.

In FIG. 3, a foamed resin molding machine is shown in another embodiment that is an alternative to that described above. In this molding machine, foamed aluminum plates 51, 61 are laminated on the frames 5, 6, respectively. Further, foamed aluminum plates 31, 41 are also laminated on the back plates 3, 4, respectively. As a method for laminating these plates, an appropriate method such as bonding or screwing may be employed. Foamed aluminum plates may also be laminated onto the center plates 71, 81, respectively. As a result of the lamination of the foamed aluminum plates, the heat insulation effects of the frames 5, 6 and of the back plates 3, 4 can be significantly increased.

Further, in FIG. 4, a foamed resin molding machine that incorporates back plates 3, 4 in a sandwiched structure is shown. Specifically, the back plate 3 includes a foamed aluminum plate 33 that is interposed between aluminum plates 32, and the back plate 4 includes a foamed aluminum plate 43 that is interposed between aluminum plates 42. The back plates 3, 4, by virtue of being constituted in a sandwiched structure, can also achieve an enhanced degree of heat insulation effects.

### Example

The foamed resin molding machine of the present invention including the frames 5, 6 and the back plates 3, 4, all of which were made of foamed aluminum, as shown in FIG. 2, and a conventional foamed resin molding machine including frames and back plates all of which were made of metal aluminum as shown in FIG. 1 were continuously operated, and their performances were compared with those of each other. Specifically, variations in temperatures (ST) of the frames during one cycle of heating by steam and cooling by cooling water were compared.

At the time of the experiments, a raw material of thermoplastic resin particles having a foaming property was first of all poured into the cavity 19 by means of a raw material-filling machine 11. Next, steam was introduced from the steam introduction sections 15, 16 into the steam rooms 9, 10. The steam, introduced into the cavity 19 through steam holes that had been provided in the recessed die 8 and the protruded die 9, heats the raw material so as to foam and fuse it into a molded body 20. Increases in temperatures T1 of the frames 5, 6 at this time were measured by means of thermocouples embedded in the frames 5, 6.

After completion of the fusion, cooling water was supplied from the cooling water introduction sections 13, 14 via the cooling water pipes 17, 18, and the cooling water was sprayed onto the back surfaces of the recessed die 7 and the protruded die 8 through nozzles 21, 22, so as to cool the molded body 19 within the cavity. The temperatures T2 of the frames 5, 6 after completion of the cooling were measured by means of thermocouples. The differences between temperatures T1 and T2 are compared as ΔT. The results of the experiment are shown in Table 1.

TABLE 1

| | Frame at fixed-side | | | Frame at movable-side | | |
|---|---|---|---|---|---|---|
| | die plate | | | die plate | | |
| | Position | | | | | |
| | Upper | Middle | Lower | Upper | Middle | Lower |
| | portion | portion | portion | portion | portion | portion |
| Conventional | 22.7 | 24.6 | 34.5 | 14.6 | 16.7 | 31 |
| example | | | | | | |
| Present | 6.3 | 6.6 | 14.4 | 6.5 | 4.6 | 14.8 |
| example | | | | | | |

As shown in the above, whereas the difference in temperature ΔT was as much as between 19.6 and 34.5° C. in the cases of conventional machinery, in the example in which the foamed aluminum was used, it was possible to suppress the difference in the temperature ΔT to between 4.6 and 14.8° C., a reduction to a smaller value that was equivalent to about ⅓ of that in the case of conventional machinery. This reduction can be attributed to the fact that increases in the temperatures of the frames 5, 6 were reduced to modest levels. It goes without saying that increases in the temperatures of the back plates 3, 4 were also accordingly reduced to modest level.

As described above, as a result of the enhancement of the degree of the heat insulation properties of the frames 5, 6 and the back plates 7, 8, a reduction in cycle times and a reduction in the amount of steam used were achieved. In addition to these effects, reductions in the consumption of power were also achieved as a result of the reductions in weight. A combination of these effects has led to significant reductions in costs.

1. A steam room in a foamed resin molding machine, comprising: a die; a frame; a back plate; and a center plate, wherein at least one of the frame, the back plate, and the center plate is made of a porous metal for the purposes of heat insulation.

2. A steam room in a foamed resin molding machine, comprising: a die; a frame; a back plate; and a center plate, wherein a porous metal for heat insulation is laminated on an inner surface of at least one of the frame, the back plate, and the center plate.

3. A steam room in a foamed resin molding machine, comprising: a die; a frame; a back plate; and a center plate, wherein the back plate is constituted in a sandwiched structure that incorporates a porous metal plate for heat insulation and that is laminated so as to be interposed between metal plates.

4. A steam room according to claim 1, wherein foamed aluminum or foamed magnesium is employed as the porous metal for heat insulation.

5. A foamed resin molding machine, comprising the steam room according to claim 1.

6. A method for molding a foamed resin, comprising the steps of foaming and molding a raw material of thermoplastic resin particles by means of the foamed resin molding machine according to claim 5.
